(19) United States
(12) Patent Application Publication
(10) Pub. No.: US 2013/0271606 A1
(43) Pub. Date: Oct. 17, 2013

(54) METHOD OF DISPLAYING AN ASSISTANT SCREEN FOR IMPROVING DRIVING SAFETY OF A VEHICLE

(71) Applicant: PAUL CHIANG, Taipei City (TW)

(72) Inventor: Paul Chiang, Taipei City (TW)

(73) Assignee: Paul Chiang, Taipei City (TW)

(21) Appl. No.: 13/745,666

(22) Filed: Jan. 18, 2013

(30) Foreign Application Priority Data
Apr. 13, 2012 (TW) 101113321

(51) Int. Cl. H04N 7/18

(52) U.S. Cl. CPC H04N 7/183
USPC 348/148

(57) ABSTRACT

A display method includes: detecting objects by sensor array; utilizing an environment reconstruction unit for receiving sensing information from the sensor array and perform a reconstruction process based on the sensing information and transforming the latter into object coordinate based on user-chosen mode; and utilizing a display device to display an iconized environment video or scene resulted by integrating an indicative icon of the object with the object coordinate.

### CROSS-REFERENCES TO RELATED APPLICATIONS

This application claims the priority of Taiwanese patent application No. 101113321, filed on Apr. 13, 2012, which is incorporated herewith by reference.

### BACKGROUND OF THE INVENTION

1. Field of the Invention

The present invention relates to a display method for an assistant screen installed within or around a vehicle, more particularly a method for displaying an assistant screen in order to improve the driving safety of the vehicle, in which the assistant screen displays a bird's eye view, lateral side views or 3D view of ambient environment of the vehicle.

2. The Prior Arts

To prevent occurrence of accidents in vehicles (such as cars, motorbikes, boats and even planes) due to blind spot during driving of the vehicle becomes a major concern, especially for those manufacturers producing safety devices. A variety of safety systems have been developed lately, some utilizing laser beams, infrared rays, ultrasonic, microwaves, radio frequency, light sensors, image capturing device, to detect the ambient environment of the vehicle (such as pedestrians, nearby cars or road obstacles) so as to inform or remind the driver about the actual situation of the road on which he is driving. Mostly used safety systems include ultrasonic backing system, rear camera system and Blind Spot Information System employed in Volvo cars.

A conventional car is generally installed with a rear-view mirror for viewing rear image behind the car and left and right mirrors at left and right sides thereof for viewing the lateral sides thereof. Nevertheless, there are still a lot of blind spot, which the driver cannot see during the driving action, thereby leading to misjudging distance of an adjacent or approaching car and hence causing undesired accidents. In addition, the car dashboard is provided with a plurality of indicator lights, needles and digits, which shows the operation modes of the cars. For instance, turning indicator, hand-brake light, the driving speed, the mileage, the fuel gauge and etc. are also provided within the car such that the driver has to see these meters in addition to observing the different viewing mirrors. Hence a great deal of concentration or attention is needed for the driver to swiftly judge the road condition in order to avoid occurrence of collision or accident.

A modern vehicle is generally installed with a rear video system, which enables the driver to view the rear scene and the invisible angles during the backing or parking operation, or with a BLIS system to remind and facilitate in changing of driving lane and hence eliminating the undesired collision with the lateral cars. In addition, alert lights are also employed to alert the driver about the cars approaching from left and right sides thereof. Image-capturing devices are provided at two lateral sides of the car to view the lateral scene or images or short and long alert sounds are used to remind the driver about the distance of a car approaching from behind. However, these safety assisting instruments require the driver to personally view or identify the scene or image, or alternately he must intermittently neglect the front view and keep head down or up to view the rear scene, thereby resulting in burden to perceptual concentration of the driver and adversely increasing the possibility of occurrence of accidents.

The conventional safety system in addition to implementing traditional mirrors, several other safety devices, like radars, image-capturing device, detection means, display screens, alert lighting and alarm sound are provided as references for the driver. The more the devices are provided the busier the driver becomes such that in case of encountering an accident suddenly, he is left in a position whether to listen or recognizes, which device generates the alarm sound or alert light. He has to watch the display screen, bends his head downside and a little time is needed to understand what is happening around this car. These types of problems often occur in those pilots navigating the planes owing to too many complicated meters. Too many alarm lights or sounds eventually lead the driver to nervousness and causing indefiniteness in judging the ambient environment, thereby incurring collision against an adjacent car. In view of this, the above-mentioned safety devices should be integrated into an integral member that may assist the driver during the driving operation.

Utilizing so many detection devices to assist the driving action, the achieved object is restricted owing to different characteristics of the detection devices, some provide a small detection range, some is swift in their response, while the other require more power consumption, like scanning the environment ceaselessly in 360 degrees, some are easily interfered, some are sensitive to high or weak light. In the same manner, each detection device provides a specific task, such as alert lighting or alarm buzzing sound and hence a safety measure, however the detection devices still required to be integrated as one integral member in order to avoid nervousness and confusion in the driver or the pilot navigating the planes provided with complicated meters.

Therefore, a method of displaying an assistant screen for improving driving safety of a vehicle is urgently needed, which can provide information to reduce the burden or concentration of the driver so as to assist in enhancing the correct responsive action to avoid the occurrence of collision against nearby vehicles or accidents.

### SUMMARY OF THE INVENTION

Therefore, the objective of the present invention is to provide a method of displaying an assistant screen for improving driving safety of a vehicle, in which a sensor array is utilized to detect a sensing information of a nearby object. An environment reconstruction unit is utilized, which includes an object icon database for recording one indicative icon of the object and an object coordinate transformation unit for transforming the sensing information into an object coordinate so as to generate a bird's eye view, lateral side view and 3D view of iconized environment scene or video of ambient environment of the vehicle that is displayed over the assistant screen.

The sensor array further includes a plurality of the sensors. Each of the sensors is selected from a group consisting of a laser device, an infrared device, an ultrasonic device, a microwave device, an electromagnetic device, a photo-sensitive device, a camera device, and an image recognition device or RFID (radio frequency identification). These sensors are used for detecting the different positions or identification information of objects around the vehicle, such as car passing by or pedestrians crossing the road, platform of the road and the driving lanes.

The object icon database is used for recording at least one indicative icon for the object of different types or identification information. An unknown object, which has no indicative icon, is represented by a specific pattern. The indicative icon may include an actual image of the object or any types of shapes. The object coordinate transformation unit performs reconstruction process based on the sensing information, position and distance of the object so as to generate object coordinate of the object. In addition, the environment reconstruction unit further includes a sensor position database for recording relative positions of the sensors relative to the vehicle so that those sensors position information will help to calibrate the coordinates of its detected objects.

The iconized environment video or scene is formed by integrating the indicative icon of the object with the sensing information so as to be displayed over the assistant screen. The iconized environment video may include easily identified colored block, pattern, line, symbol or original image of the object, which are displayed in the bird's eye view, the lateral side view of 3D view. Thus, when the method of the present invention is implemented in a vehicle, the drive can precisely judge the ambient environment of the vehicle he is driving, thereby providing driving safety so as to prevent occurrence of undesired accident.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows a block diagram illustrating the steps in a method of the present invention method for displaying an assistant screen in order to improve driving safety of a vehicle;

FIG. 2 shows a bird's eye view of ambient environment of the vehicle that is installed with the method of for displaying the assistant screen in order to improve driving safety of the vehicle in accordance with the present invention;

FIG. 3 shows a lateral side view of ambient environment of the vehicle that is installed with the method for displaying the assistant screen in order to improve driving safety of the vehicle in accordance with the present invention;

FIG. 4 shows a perspective side (3D) view of ambient environment of the vehicle that is installed with the method for displaying the assistant screen in order to improve driving safety of the vehicle in accordance with the present invention;

FIG. 5 illustrates an example of ambient environment of the vehicle that help to explain how the method work; and

FIG. 6 illustrates the assistant screen displays of a bird's eye view that is the result of the method in the example of FIG. 5.

### DETAILED DESCRIPTION OF THE PREFERRED EMBODIMENTS

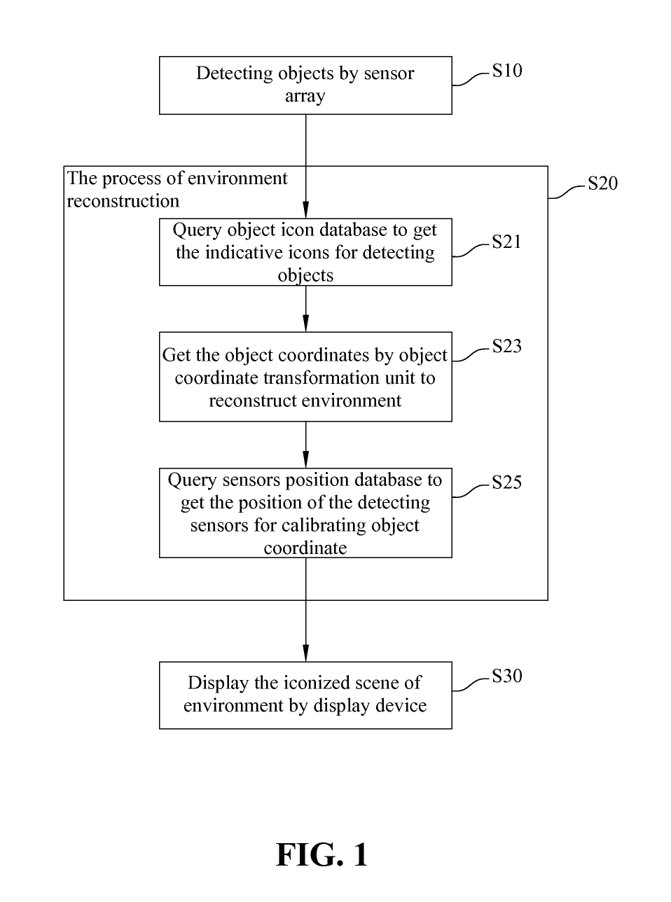

FIG. 1 shows a block diagram illustrating the steps in a method of the present invention method for displaying an assistant screen in order to improve driving safety of a vehicle. As illustrated, the method of the present invention includes S10, S20 and S30, which are used to generate an iconized environment video (scene) (i.e., ambient environment of the vehicle), which is displayed over the assistant screen so that a driver driving the vehicle can precisely judge the ambient environment as well as the traffic (car passing by or pedestrians crossing the road), thereby providing safety information so as to avoid occurrence of collision against nearby cars or accidents.

As illustrated, in the step S10: a sensor array is utilized to detect at least one object around the vehicle to generate and to transmit to an environment reconstruction unit, which is connected with the sensor array wirelessly or via a wire by analog or digital signals. The sensor array is generally installed within or around the vehicle, and includes at least one sensor. The sensing information contains a position, a distance or identification information of the object with respect to the vehicle. The identification information of the object is not always detected and optionally, it depends on the type of sensors. The sensor array may include a plurality of the sensors disposed at different positions within or around the vehicle, respectively, for sensing the cars passing nearby, pedestrians walking along the platform or crossing the streets or the peripheral edges of nearby lanes. Each of the sensors is selected from a group consisting of a laser device, an infrared device, an ultrasonic device, a microwave device, an electromagnetic device, a photo-sensitive device, a camera device, an image recognition device or RFID (Radio-frequency identification). An image recognition device or RFID could make the identification information.

The sensor array may further include a plurality of laser distance measurers, each measure emitted laser beams of different directions and each receives laser beams reflected from the object so as to measure distances of the objects with respect to the laser distance measurers in different directions. In addition, the sensor array further includes a rotation seat or cradle head for seating a respective one of the sensors thereon in order to increase a detecting range.

According to the step S20, the environment reconstruction unit is utilized for receiving the sensing information and for performing a reconstruction process based on the sensing information, wherein the environment reconstruction unit includes an object icon database and an object coordinate transformation unit. The environment reconstruction unit is integrating with the indicative icon of the object into an iconized environment video (scene). Finally, in the step S30: a display device is utilized for receiving and displaying the iconized environment video (scene) over the assistant screen such that the driver can observe the ambient environment of the vehicle he or she is driving.

To be more specific, the step S20 further includes steps S21 and S23, which separately or simultaneously perform some tasks, wherein in the step S21, the object icon database is used for recording at least one indicative icon for the object of different types and in the step S23, the object coordinate transformation unit is used for transforming the sensing information into an object coordinate according to user-chosen display mode. At this time, the display device is used for receiving and displaying the iconized environment video (scene) (the ambient environment of the vehicle) over the assistant screen.

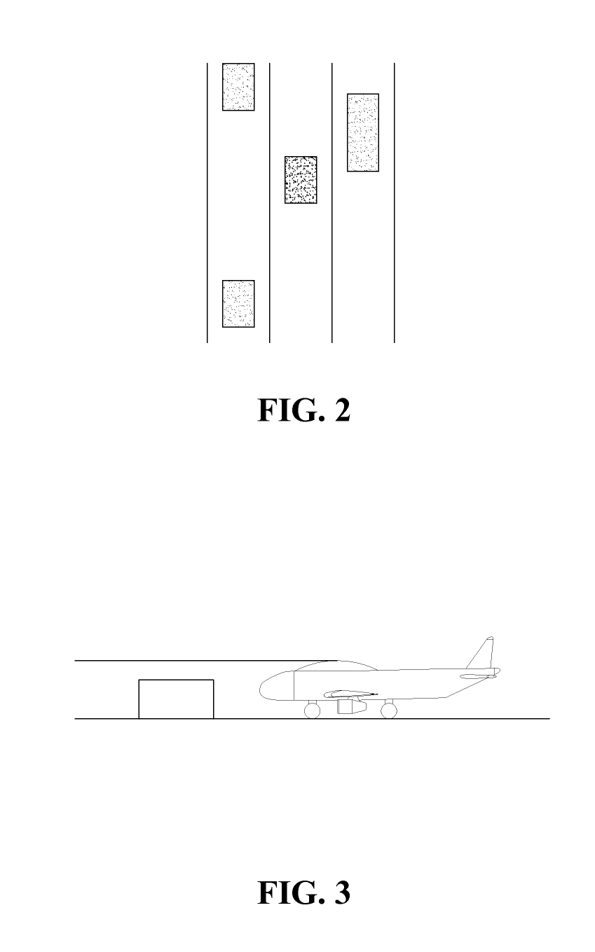

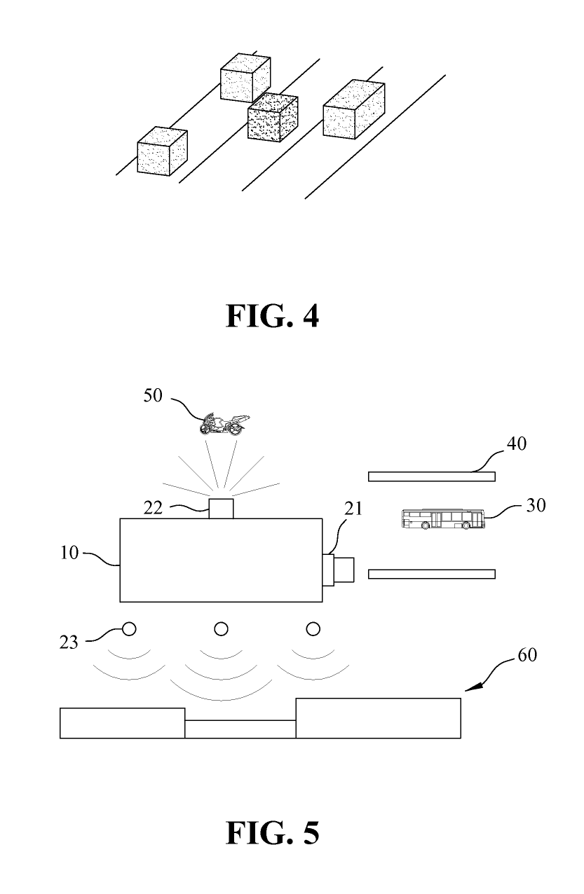

The above-mentioned user-chosen display mode includes a bird's eye view, lateral side views or perspective (3D) views of different angles of ambient environment of the vehicle. The indicative icon for the object may include a colored block, pattern, lines, symbols or original image of the object. For instance, FIG. 2 shows a bird's eye view of ambient environment, wherein the blocks represent adjacent vehicles respectively while the straight lines represent and divide the road into several driving lanes, each of the blocks is indicated by different colors, the middle ones being the vehicle (in Blue you are driving) installed with the method of the present invention for providing improved safety, the left and right side cars are respectively represented by Green, the right car being located at the nearest distance with respect to your car, the car behind on the left side is the spaced at the greatest distance relative to your car. The displayed size and space of the indicative icon is relevant to the real distance and position of a respective car. FIG. 3 shows a lateral side view of ambient environment of the vehicle that is installed with the method for displaying the assistant screen in order to improve driving safety of the vehicle in accordance with the present invention. In this embodiment, the vehicle is a plane, where the pilot is unable to view the obstacle left in front of the plane. The obstacle can be a signal board, a van or a container, their respective height is much below the wings of the plane. The height of the obstacle may be about 8 meters while the wings of the plane are about 10 meters. Under such condition, the pilot can judge precisely that the wings will not collide against the obstacles during the plane take off from the ground. FIG. 4 shows a perspective side (3D) view of ambient environment of the vehicle that is installed with the method for displaying the assistant screen in order to improve driving safety of the vehicle in accordance with the present invention, wherein the blocks represent adjacent vehicles respectively while the oblique lines represent and divide the road into several driving lanes, the remaining features are the same as disclosed in FIG. 2.

The above-mentioned image recognition device is capable of capturing a video (scene) (object or image) shot by the camera device, then recognizes the object and generates an object identification information. For a moving vehicle, the method of recognizing objects from cameras could recognize by object shadow, outline or shape, it does not compare successive video frames to recognize objects. The object distance could be recognized by image pixels from one camera or by the Parallax of two or more cameras. The RFID (Radio-frequency identification) is used for reading an identification information contained in a RFID tag that is attached on the object and generates the object identification code for the sensing information to indicate the corresponding icon of the object in the object icon database.

The step S20 could further includes steps S25, wherein the environment reconstruction unit further includes a sensor position database for recording positions of the sensors within or around the vehicle such that the position of the sensors on the vehicle can be adjusted to the most appropriate position, where the respective sensor can detect a distance with respect to a nearby object to the uttermost precision. The object coordinate transformation unit calibrates the distance and position as the object coordinates such that the driver can take the same as reference for judging the ambient environment he is driving.

FIG. 5 illustrates ambient environment of the vehicle that is installed with the method of the present invention, wherein the assistant screen displays nearby objects detected by the method of the present invention. In this embodiment, the vehicle 10 is a car, which is provided with three different sensors; namely a first sensor unit 21 installed at the front portion of the car, a second sensor unit 22 installed on the left side of the car while a third sensor unit 23 installed on the right side thereof. The first sensor unit 21 is composed of the camera device and the image recognition device. The second sensor unit 22 is composed of the rotary laser scanner or six pieces of laser distance measurers while the third sensor unit 23 is composed of three microwave devices which are spaced apart from one another. The sensor position database records the positions of the sensor units within or around the vehicle.

The camera device of the first sensor unit 21 captures the images (objects) in front and the image recognition device recognizes and interprets the objects into cars, pedestrians, obstacles or driving lanes into the sensing information (including position, distance or identification information of the object), which are transmitted to the environment reconstruction unit, the unit query the object icon database and the object coordinate transformation unit to get the object indicative icons (or its original image) and the object coordinate of the respective sensing information. Finally, the iconized environment is displayed over the assistant screen. For instance, in FIG. 5, a car is located 10 meters in front on the left side, two driving lanes 40, one of which is immediately right in front while the other one is located in the front at the left side and is spaced apart 15 meters from your car.

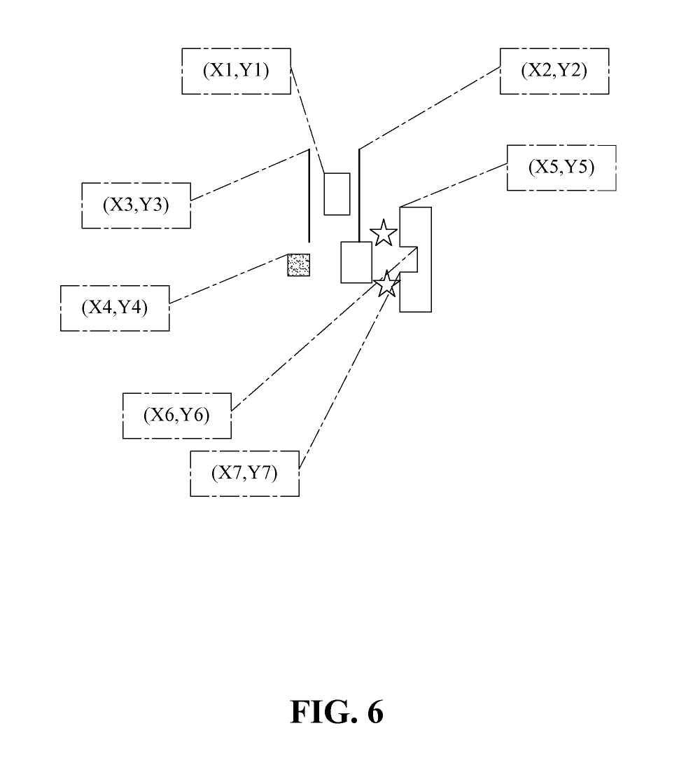

Querying the object icon database of the environment reconstruction unit, the yellow block represents the car, and the black lines represent the driving lanes. Querying the sensor position database of the environment reconstruction unit, you may know that three objects (one vehicle, two separation lanes; one right ahead, the other at the front left side) are located in front of your car. At this condition, the object coordinate transformation unit transforms the sensing information into an object coordinate according to the user-chosen display mode (the bird's eye view as FIG. 6), which means three object coordinates respectively indicate a car is located 10 meters away in the front side, one separation lane is immediately right in front while the other one is located in the front at the left side and is spaced apart 15 meters from your car. Hence, the object coordinate transformation unit transforms three pieces of the sensing information into three object coordinates (X1, Y1), (X2, Y2) and (X3, Y3) as shown in FIG. 6, wherein the object coordinate (X1, Y1) shows a yellow block representing a yellow car while the object coordinates (X2, Y2) and (X3, Y3) at the upper portion respectively show the black lines representing two lanes.

The camera device and the image recognition device recognize and interpret a distance of an object with respect to the vehicle in terms of pixel information, which, in turn, are calculated into actual miles. Therefore, since the first sensor unit is composed of the camera device and the image recognition device, which finally integrate with the indicative icon of the objects into the iconized environment video (scene) as shown in FIG. 6.

In addition, the second sensor unit 22 emits laser beams to 6 different angles (25.7°, 51.4°, 77.1°, 102.9°, 128.6°, 154.3° respectively) in order to scan the central portion of the left side, the front left side and the rear left side. The distance of the object with respect to the vehicle is measured based on the reflected laser beams from the respective object. As illustrated in FIG. 5, a motorbike 50 is detected on the left side of the vehicle 10, therefore the four laser beams (25.7°, 51.4°, 128.6°, 154.3°) at the front and rear portions do not reach the motorbike 50 and only the two laser beams (77.1°, 102.9°) at the central portion reflected from the motorbike after hitting the same. The reflected laser beams and the time required for reflection are calculated to result a distance of 2 meters. This message is transmitted to the environment reconstruction unit but its indicative icon of the object is not known, because the laser scanner cannot identify the identification information of objects and the environment reconstruction unit treats it as an unknown object.

Querying the object icon database of the environment reconstruction unit, it is discovered that the black block represents an unknown object. Querying the sensor position database of the environment reconstruction unit, it is found that said sensor unit is installed on the left side so that the sensing information (2 meters leftward from topside view) is transmitted to the environment reconstruction unit, which transforms the same into an object coordinate (X4, Y4), as best shown in FIG. 6, which is recognized as an unknown object.

Collision against an unknown object (black block) also leads to undesired accident. Therefore, it is unnecessary to get the object identification information of each object. If the actual identification information of the object is required to be recognized, the camera device and the image recognition device should be required to be involved. Alternately, the RFID (Radio-frequency identification) can be implemented for reading an identification information contained in a RFID tag that is attached on the object (motorbike) and get the object indicative icon for replacement of the black block. In short, the sensor unit composed of the laser scanner and laser distance measurers can be adapted to the method, and make the iconized environment video (scene), as shown in FIG. 6.

In FIG. 5, the third sensor unit 23 includes three microwave devices mounted respectively at the middle, front and rear portions of the right of the vehicle 10. The microwave devices are to get the reflecting strength or reflecting time of its reflecting microwave so as to detect the distances of the ambient obstacles. In the example, the obstacles 60 at the front and rear right sides are detected one meter from the vehicle while the middle obstacle 60 is detected 1.5 meters from the vehicle 10. Since this type of sensor unit cannot detect the identification information of the object and the environment reconstruction unit recognizes that an unknown object is located and spaced apart 1.5 meter from the vehicle 10 while the other two unknown objects are respectively spaced apart 1 meter from the vehicle 10.

Querying the object icon database of the environment reconstruction unit, it is discovered that three black blocks represent three unknown objects. Querying the sensor position database of the environment reconstruction unit, it is found that said three sensors are mounted respectively at the middle, front and rear portions of the right of vehicle 10. The environment reconstruction unit transforms the same into object coordinates, as viewed from a topside thereof, the three sensing information respectively indicate one meter frontward on the right side; one meter rearward on the right side and 1.5 meter perpendicularly away from the middle of the vehicle 10. After conversion by the environment reconstruction unit, three object coordinates are (X5, Y5), (X6, Y6) and (X7, Y7). Hence, in FIG. 6, the three object coordinates (X5, Y5), (X6, Y6) and (X7, Y7) on the right side represent an obstacle having a black pattern with an inwardly dented portion. Since this type of sensor unit cannot identify the identification information of the objects, the environment reconstruction unit makes them as black patterns even it could be as a road fence or a truck with a trailer (having a dented recess in the middle).

In addition, the environment reconstruction unit is able to recognize the positions and distances of the nearby objects and can generate simple symbols relative to the distance of the nearby objects. For instance, the system can be configured in such a manner to remind the driver that when the distance of the objects on the left and right sides spaced apart from the vehicle is equal to less than one meter is considered as hazardous. When encountering such a situation, the assistant screen will display a sort of symbol reminding the hazardous condition. In FIG. 6, since the distance of the objects on the front and rear right side is equal to or less than one meter, the assistant screen display two symbols in the form of red star between the vehicle and the obstacle, reminding the driver the hazardous condition.

Whatever the case, collision against an unknown object (black block) also leads to undesired accident. Therefore, it is unnecessary to identifying the object identification information of each object. If the actual identification information of the object is required to be recognized, the camera device and the image recognition device should be required to be involved. Alternately, the RFID (Radio-frequency identification) can be implemented for reading identification information contained in a RFID tag that is attached on the object and generates the object identification code for replacement of the black block. In short, the sensor unit composed of several pieces of microwave devices, which can finally integrate with the indicative icon of the objects into the iconized environment video (scene). The characteristic of the microwave device is similar to ultrared rays, ultrasonic radar and radio waves so that the ultimate result is the same.

The display device mentioned in the step S30 can be a matrix of lights, which is cheap in cost and includes a matrix of LEDs (Light Emitting Diode). The object icon database of the environment reconstruction unit can be simplified by certain light symbols (of different objects) for representing different vehicles, such as a light matrix of 3×2 (3 LEDs in the horizontal direction and 2 LEDs in the vertical direction) for a car; a light matrix of 1×20 (20 LEDs in the horizontal direction and one LED in the vertical direction) for the lane. The object coordinate of the environment reconstruction unit can be transformed into specific light positions, for instance, the coordinate (4, 5) can be a beginning light at row 4 and column 5. Arranging such cheap light matrix for identifying the nearby object such that entire ambient environment is display over the assistant LED matrix so as to judge the distance of a respective object relative to the vehicle you are driving.

Regardless of how the sensors of different types communicate with the environment reconstruction unit, even a sensing information of a single position of a nearby object is obtained, the environment reconstruction unit can integrate the indicative icon of the object into an iconized environment video (scene), in which the nearby objects are displayed in terms of colored block, minimized size of the actual image. It is to note that the above embodiments are given for better understanding of the present invention, the scope and spirit of the present invention should not limited only to these embodiments.

As described above, the method of the present invention for displaying an assistant screen can summarize the sensing information provided by the sensor array so as to show an iconized environment video (scene) of ambient environment of the vehicle, thereby providing driving safety measures in addition to precise swift response in a desire time. Hence, those undesired road accident can be avoided.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method of displaying an assistant screen for improving driving safety of a vehicle, comprising:
utilizing a sensor array including at least one sensor that is adapted to disposed within or around the vehicle to detect at least one object around the vehicle and that generates a sensing information which contains a position or distance of said object;
utilizing an environment reconstruction unit for receiving said sensing information through wired or wireless connections and for performing a reconstruction process based on said sensing information, wherein said environment reconstruction unit includes an object icon database for recording at least one indicative icon for said object of different types and an object coordinate transformation unit for transforming said sensing information into an object coordinate according to user-chosen display mode, said environment reconstruction unit integrating with said indicative icon of said object into an iconized environment video; and
utilizing a display device for receiving and displaying said iconized environment video over the assistant screen.

2. The method according to claim 1, wherein said user-chosen display mode is selected from a group consisting of a bird's eye view, a lateral side view or a 3D view.

3. The method according to claim 1, wherein said sensor array further includes a plurality of said sensors disposed at different positions within or around the vehicle, respectively, each of said sensors being selected from a group consisting of a laser device, an infrared device, an ultrasonic device, a microwave device, an electromagnetic device, a photo-sensitive device, a camera device, an image recognition device or RFID (radio frequency identification), said image recognition device capable of capturing a video from said camera device and then recognizing said object and generating an object identification code, said RFID being used for reading an identification information contained in a RFID tag that is attached on said object and that generates said object identification code for said sensing information to indicate the corresponding icon of said object in said object icon database.

4. The method according to claim 3, wherein said sensor array further includes a plurality of laser distance measurers, each measure emitted laser beams of different directions and each receives laser beams reflected from said object so as to measure distances of said objects with respect to said laser distance measurers in different directions.

5. The method according to claim 1, wherein said indicative icon includes a colored block, pattern, line, symbol or original image of said object, wherein displayed size and space of said indicative icons are relevant to a real distance of said object.

6. The method according to claim 1, wherein said environment reconstruction unit further includes a sensor position database for recording positions of said sensors within or around the vehicle, which are provided for said object coordinate transformation unit to calibrate its detected object coordinates.

7. The method according to claim 1, wherein said sensor array further includes a rotation seat or cradle head for seating a respective one of said sensors thereon to increase a detecting range with respect to said object.

8. The method according to claim 1, wherein said display device is a matrix of lights for displaying different light signs, which includes a matrix of LEDs (light emitting diodes), said object icon database being used for recording light (symbols) signs corresponding to different types of said objects.
